(19) United States
(12) Patent Application Publication
(10) Pub. No.: US 2019/0054438 A1
(43) Pub. Date: Feb. 21, 2019

(54) ASSEMBLY FOR SYNTHESIS OF A SUPERHARD MATERIAL

(71) Applicant: ELEMENT SIX (UK) LIMITED, DIDCOT, OXFORDSHIRE (GB)

(72) Inventors: MOHAMMAD NAJAFI SANI, DIDCOT (GB); VICTOR MANUEL MARQUES DE AZEVEDO SALES, DIDCOT (GB); RACHAEL FIONA AMBURY, DIDCOT (GB); SUCHI SUBHRA MUKHERJI, DIDCOT (GB)

(73) Assignee: ELEMENT SIX (UK) LIMITED, DIDCOT, OXFORDSHIRE (GB)

(21) Appl. No.: 16/080,099

(22) PCT Filed: Mar. 15, 2017
(86) PCT No.: PCT/EP2017/056149

§ 371 Date: Aug. 27, 2018

(30) Foreign Application Priority Data
Mar. 16, 2016 (GB) 1604453.9

(51) Int. Cl. B01J 3/03; B01J 3/06

(52) U.S. Cl. CPC B01J 3/03; B01J 3/062; B01J 3/065; B01J 2203/062; B01J 2203/0685; B01J 2203/0645; B01J 2203/0655; B01J 2203/066; B01J 2203/063

(57) ABSTRACT

An assembly for High Pressure High Temperature (HPHT) synthesis of a superhard material. The assembly comprises a container comprising a first metal. A closure also comprising the first metal is sealed to the container using a sealant material. The sealant material comprises a second metal, the seal comprising a composition of the first and second metals formable below the melting point of the second metal. The container contains superhard material.

### FIELD

The invention relates to the field of assemblies for high pressure high temperature synthesis of superhard materials, and to methods for forming such assemblies.

### BACKGROUND

High Pressure High Temperature (HPHT) synthesis of superhard materials such as synthetic diamond material is well known in the art. For example, a process for manufacturing a polycrystalline diamond (PCD) compact involves placing diamond powders into an assembly and loading the assembly into a press where it is subjected to a pressure exceeding 3.5 GPa and a temperature exceeding 1000° C.

Referring to FIG. 1, there is illustrated schematically a side elevation cross section view of an assembly 100 for loading into an HPHT press. To prepare the assembly, a charge 101 is provided that includes precursor materials for the superhard material. This may include superhard materials, binders, a cemented metal carbide substrate and so on. The charge 101 may be enclosed in a material that is substantially non-reactive with respect to the precursor materials.

The charge 101 is located in a container that comprises a first cup 102 and a second cup 103. The opening of the second cup 103 is flared out so that its inner diameter is slightly greater than the outer diameter of the first cup 102. The two cups are then welded together by a technique such as electron beam welding.

Attempts have been made to seal assemblies using copper as a sealant. U.S. Pat. No. 7,575,425 and US 2005/0044800 describe processes in which the temperature is raised to the melting point of copper, allowing the copper to form a liquid and flow to form a seal. However, this means that liquid copper can infiltrate the assembly, which is detrimental to the superhard material properties. A more serious problem is that copper fumes are evolved, which can also infiltrate the super-hard material.

The problem is exacerbated when the superhard material is enclosed in a material that is substantially non-reactive with respect to the precursor materials. In this case the superhard material may be outgassed prior to locating it in the container. However, after outgassing and before welding the container closed, the superhard material is returned to ambient temperature and pressure. This makes the process more time consuming, as there is an outgassing step followed by a sealing step.

### SUMMARY

It is an object to provide an assembly for HPHT production of superhard materials and a method of forming an assembly that mitigates the problems described above.

According to a first aspect, there is provided an assembly for High Pressure High Temperature (HPHT) synthesis of a superhard material. The assembly comprises a container comprising a first metal. A closure also comprising the first metal is sealed to the container using a sealant material. The sealant material comprises a second metal, the seal comprising a composition of the first and second metals formable below the melting point of the second metal. The container contains superhard material. Such a cup may be used to prepare a superhard material. By forming a sealant composition below the melting point of the second metal, the risk of liquid and/or fumes contaminating the superhard material is greatly reduced.

The superhard material is optionally disposed in a second container, and the second container is disposed in the container.

Optional examples of the first metal include titanium, zirconium, tantalum and alloys thereof.

Optional examples of the second metal include copper and alloys thereof.

In an optional embodiment, the first metal comprises titanium, the second metal comprises copper, and the composition comprises TiₓCu_{y}.

As an option, the container is provided with an opening for receiving the superhard material and a flange disposed around the opening. The sealant material is disposed on the flange and the closure is located such that the sealant material is disposed between the flange and the closure. The flange is crimped to hold the closure in place.

Where the assembly is substantially cylindrical, the flange and the sealant material each have an annular shape.

As an option, the superhard material comprises any of diamond, cubic boron nitride, binder material and mixtures thereof.

According to a second aspect, there is provided a method of forming an assembly for HPHT synthesis of a superhard material. The method comprises locating superhard material in a container, the container comprising a first metal and having an opening. A closure is disposed to close the opening. A sealant material comprising a second metal is disposed between the closure and the container. The assembly is heated to a temperature below the melting point of the second metal and sufficient to form a seal between the container and the closure.

The method optionally further comprises, prior to locating the superhard material in the container, disposing the superhard material in a second container and locating the second container in the container.

As an option, the method comprises, prior to heating the assembly, reducing the pressure around the assembly to perform outgassing.

The first metal is optionally selected from any of titanium, zirconium, tantalum and alloys thereof. The second metal is optionally selected from any of copper and alloys thereof. As a further option, the first metal comprises titanium, the second metal comprises copper, and the composition comprises TiₓCu_{y}.

As an option, the container comprises a flange disposed around the opening, and the sealant material is disposed between the flange and the closure. In this case, the method further comprises crimping the flange such that flange material is folded over the closure and encloses the sealant material and an outer edge of the enclosure.

As an option, the flange and the sealant material each have an annular shape.

As an option, the container comprises a first cup having an outer diameter, and the closure comprises a second cup having a second cup opening, wherein an inner diameter of the second cup proximate to the second cup opening is greater than the outer diameter of the first cup. In this case, the method further comprises disposing the sealant material between the first cup and the second cup adjacent to the second cup opening.

The superhard material optionally comprises any of diamond, cubic boron nitride, binder material and mixtures thereof.

### BRIEF DESCRIPTION OF THE DRAWINGS

Non-limiting embodiments will now be described by way of example and with reference to the accompanying drawings in which:

FIG. 1 is a schematic side elevation cross section view of a known assembly;

FIG. 2 is a schematic side elevation cross section view of exemplary assembly components before assembling;

FIG. 3 is a schematic side elevation cross section view of exemplary assembly components after assembling;

FIG. 4 is a flow diagram showing exemplary steps;

FIG. 5 is a schematic side elevation cross section view of a second exemplary assembly after assembling;

FIG. 6 is a schematic side elevation cross section view of a third exemplary assembly after assembling;

FIG. 7 is a titanium-copper phase diagram; and

FIG. 8 is an XRD trace obtained from an area around an assembly seal.

### DETAILED DESCRIPTION

It has been found that an assembly can be prepared that is sealed during the outgassing process without forming an intermediate liquid. This is achieved by forming a sealant composition around or close to a eutectic point between the metal of the container and the metal of the sealant by appropriate selection of materials such that a eutectic or near eutectic compositional seal can be made at lower temperature than would that of the melting point of primary sealant (e.g. Cu) in isolation. In addition, where an outgassing step is used, the assembly does not cool down between the outgassing step and sealing as the sealing can be performed during the outgassing step. This gives the assembly less opportunity to re-adsorb fluids such as oxygen and water, as the assembly does not need to be cooled to ambient temperature and pressure between the outgassing procedure and the sealing. Furthermore, the separate electron beam welding step is eliminated, saving time and cost.

In the examples below, the superhard material is described as polycrystalline diamond (PCD). However, it will be appreciated that the same techniques may be employed for the preparation of an assembly for preparing any type of superhard material by an HPHT process. Examples of superhard materials include PCD, diamond grit, cubic boron nitride (cBN), polycrystalline cubic boron nitride (PCBN), thermally stable polycrystalline diamond (TSP) and so on. This list is not exhaustive.

The examples below also assume that the charge of precursor materials are located in a substantially non-reactive container before disposing them in a container to be sealed. It will be appreciated that it is not necessary to dispose the precursor materials in a substantially non-reactive container.

FIGS. 2 and 3 show an exemplary assembly 200 before and after it has been assembled. In FIG. 2, a charge 201 is prepared by loading a non-reactive container with diamond powder and a cemented carbide post. Note that the cemented carbide post need not be used, but is typically provided to form a ‘backed’ PCD compact. Furthermore, the cemented carbide post may be a source of sintering aids such as cobalt during HPHT synthesis.

The non-reactive container 201is located in a container 202. In this example, the container 202 is formed from titanium. The container 202 has an opening allowing the charge 201 to enter the container 202. A flange 203 is disposed around the opening. Where the container 202 is cylindrical, the flange 203 forms an annulus around the opening.

A closure 204 is located on the flange 203 of the container 202. A washer of sealant material 205 is disposed on the closure 204. In this example, the sealant material 205 is copper.

Turning now to FIG. 3, an outer edge of the flange 203 is crimped to form a lip 301 over an outer edge of the closure 204. This sandwiches the sealant material 205 between the outer edge of the enclosure 204 and the crimped surfaces of the flange 203.

The assembly 6 then undergoes an outgassing process to reduce adsorbed fluids such as oxygen and water and gases occupying intergranular spaces. The assembly is placed in a vacuum oven and the pressure reduced to begin the outgassing process. When the required vacuum (for example, better then 10⁻³ Torr) has been achieved, the temperature is raised to a point below the melting point of the sealant metal to soften the seal 205 until a composition forms between the sealant material 205 and the metal of the container 202 and the closure 204. The composition is typically an alloy formed of the metal of the container 202 and the metal of the closure 204. In the case of a titanium container 202 and a copper sealant 205, a TiₓCu_{y} eutectic composition forms above 800° C. This composition seals the closure 204 to the flange 203 and therefore seals the container 203 completely.

Once the seal 205 has been formed the assembly 200 can be further processed and HPHT synthesis can be performed. By forming a seal 205 as part of the outgassing process, there is no need for a separate electron beam welding step. Furthermore, the assembly 200 is not returned to room temperature and pressure prior to electron beam welding, so there is little or no re-adsorption of oxygen or other contaminants.

Note that previous attempts to use a copper seal with a steel container required higher temperatures. This leads to molten copper which can flow away from the sealant area, weakening the seal. It also leads to copper fumes which can infiltrate the first container 2 and have a detrimental effect on the sintering of the final superhard material compact. The inventors have realised that by forming a composition for the seal below the melting point of the sealant metal, the evolution of fumes from the sealant material is reduced, and the risk of sealant material forming a liquid and flowing away from the sealant area is also reduced.

Furthermore, the step of crimping the flange 203 to sandwich the sealant material 205 between the flange 203 and the closure 204 helps to contain the sealant material 205 so that any liquid phases that form are unlikely to flow away from the sealant area.

While the example above refers to a titanium container 201 and a copper sealant 205, it will be appreciated that any suitable metals can be used where the sealant forms a seal below the melting point of the sealant metal. This is typically possible where a eutectic composition between the sealant metal and the container metal forms at temperatures substantially below the melting point of the sealant metal, and below the outgassing temperature.

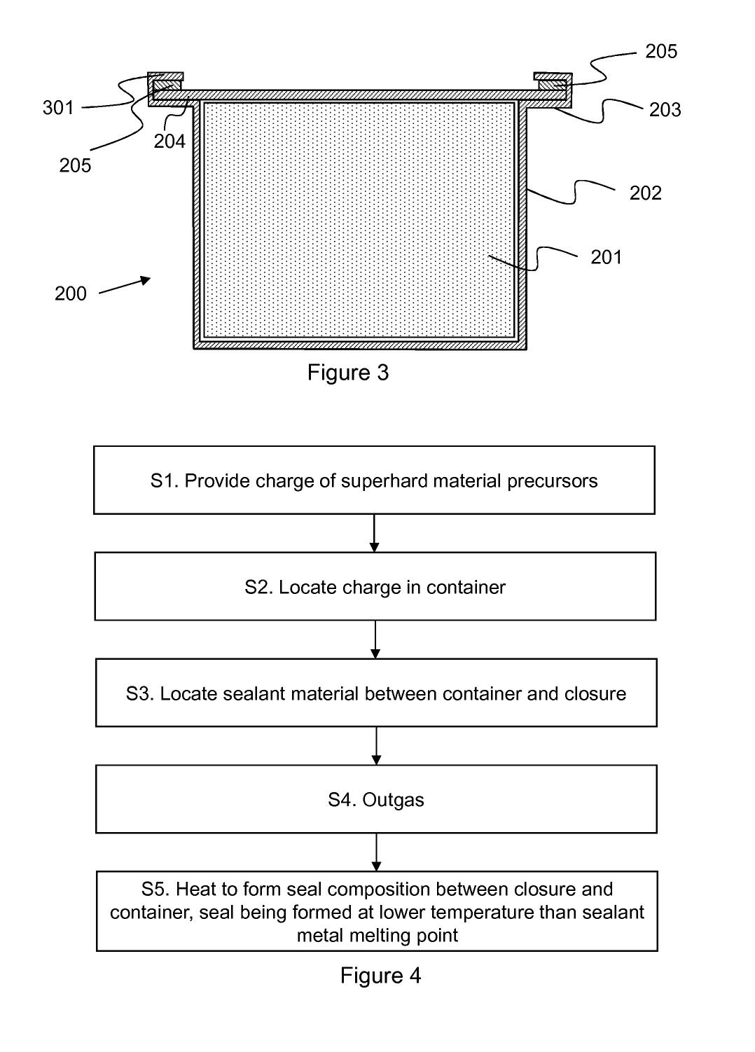

Referring to FIG. 4, a flow diagram summarizes the steps described above. The following numbering corresponds to that of FIG. 4.

S1. A charge 201 of a precursor source for the superhard material is provided. This may also include a cemented metal carbide post. As discussed above, this charge may or may not be disposed in a substantially non-reactive container.

S2. The charge 201 is located in the container 202.

S3. Sealant material 205 is located between the container 202 and the closure 204. The sealant material 205 is formed from a metal that forms a composition with the metal of the container 202 metal below the outgassing temperature and below the melting point of the sealant material 205. Depending on the shape of the container 202, the sealant 205 could be provided in the form of a washer, a ribbon, a wire, a paste or any other suitable form to ensure that the sealant is disposed in the correct location and forms a seal between the closure 204 and the container 202.

S4. The assembly 200 is placed into a vacuum oven and outgassed.

S5. While in the vacuum oven, the assembly 200 is heated to form a sealant composition between the closure 204 and container 203. The sealant composition is formed below the melting point of the sealant metal

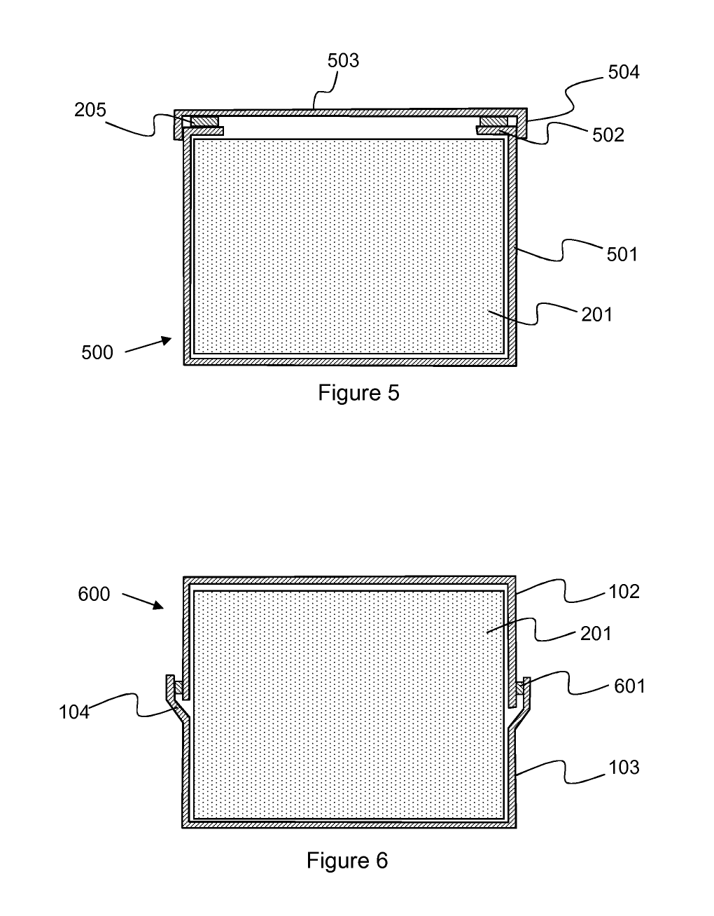

The skilled person will realise that the basic concept of using a sealant material formed from a metal that forms a composition at the outgassing temperature with the container metal that is below the melting point of the sealant metal can be applied to other container geometries. FIGS. 5 and 6 show exemplary alternative geometries.

Referring to FIG. 5, the alternative assembly 500 includes the charge 201 located inside a titanium container 501. The container 501 has an opening with a flange 502 extending around the opening. However, in this instance the flange 502 extends inwardly around the opening and partly covers an outside edge of the charge 201.

The sealant material 205 is located on the flange 502 and a closure 503 is located such that it closes the opening and the sealant material 205 is disposed between the inwardly extending flange 502 and an outer edge of the closure 503. The closure 503 provided with a lip 504 that extends to cover the side walls of the container 501 to keep the closure 503 in position. While the design of FIG. 5 does not involve crimping, and so does not hold the sealant material 205 in place as securely as a crimped design, it may be useful where there is a requirement for the assembly 500 to have a form factor that does not include a flange.

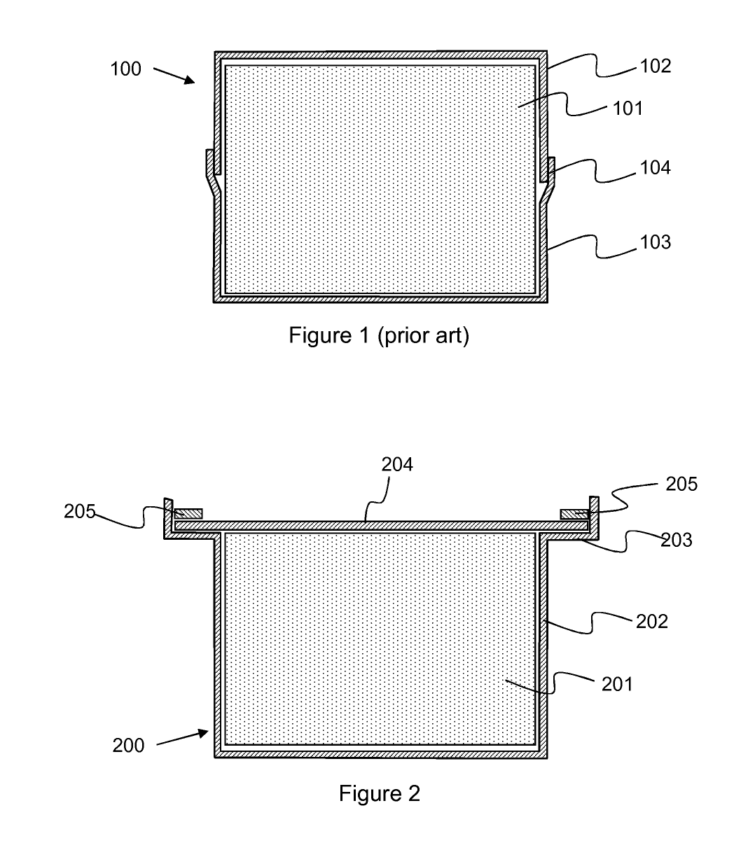

Referring to FIG. 6, an alternative assembly 600 is provided that allows use of the existing assembly 100 components shown in FIG. 1. In this instance, a ribbon of sealant material 601 is disposed between the first cup 102 and the second cup 103 at the point where the second cup 103 is flared out. The sealant 601 can be held securely in place by an interference fit between the cups 102, 103. In this example, the first cup 102 is the equivalent of the container 201 and the second cup 103 is the equivalent of the closure 204.

As discussed above, any suitable metals for the container and the sealant can be used where the sealant forms a seal below the melting point of the sealant metal, the seal comprising a mixture of the metals of the container and the sealant. Examples of suitable metals for the container include titanium, tantalum and zirconium. Titanium has an advantage that at elevated temperatures it acts as an oxygen getter, which aids clean-up of the charge. Examples of suitable metals for the sealant metal include copper, silver, palladium and gold.

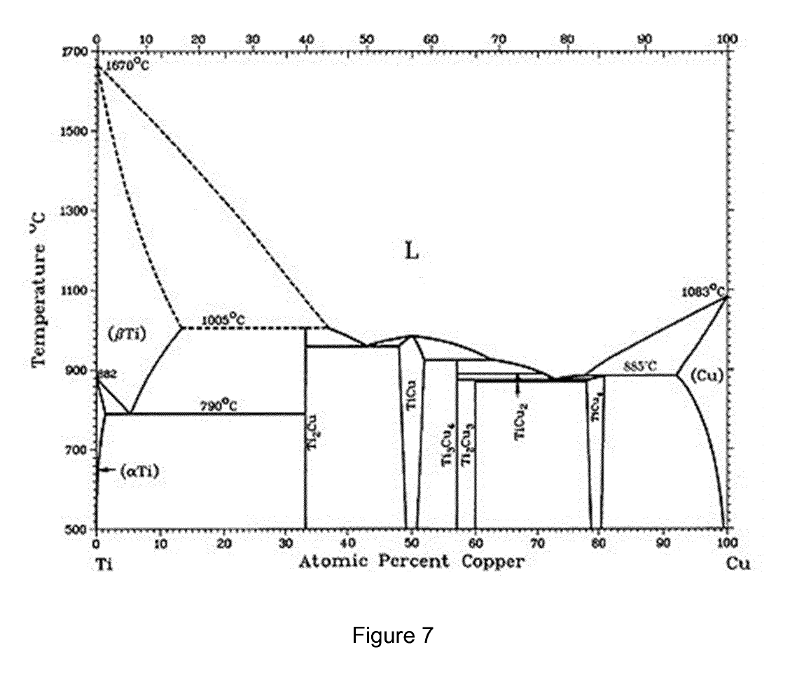

Referring to FIG. 7, there is illustrated a phase diagram for titanium-copper. It can be seen that the melting point of copper is around 1083° C. However, a eutectic composition is formed at a eutectic point below 880° C. As this is below the outgassing temperature, and below the melting point of copper, a seal forms around this point to seal the closure 204 to the container 202.

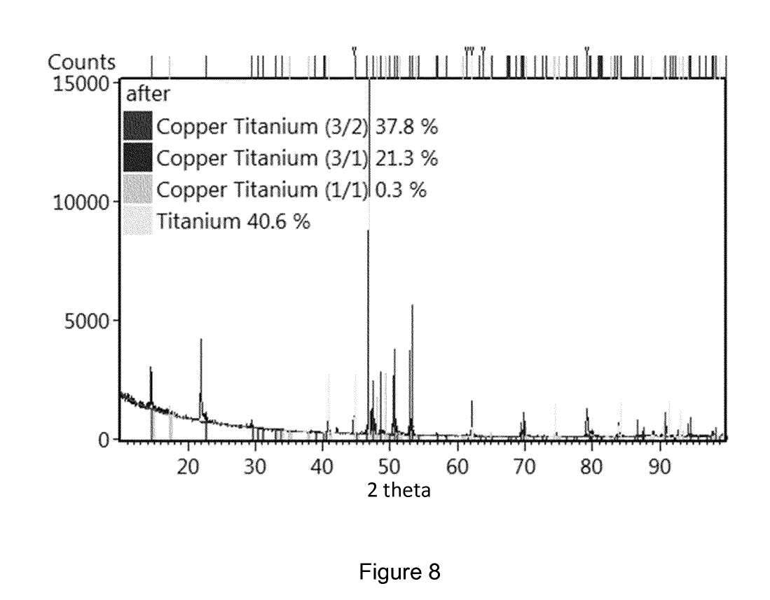

Turning now to FIG. 8, there is illustrated an X-Ray Diffraction (XRD) trace obtained from the area of the seal after the seal has been formed. The two main titanium-copper alloys formed are Ti₂Cu₃ and TiCu₃. These both have melting points at temperatures lower than the melting point of titanium or copper, and illustrate that the phases formed around the seal are formed at a lower melting point than that of pure titanium or copper.

1. An assembly for High Pressure High Temperature, HPHT, synthesis of a superhard material, the assembly comprising:
a container comprising a first metal;
a closure comprising the first metal and sealed to the container using a sealant material, the sealant material comprising a second metal, the seal comprising a composition of the first and second metals formable below the melting point of the second metal
wherein the container contains superhard material.

2. The assembly according to claim 1, wherein the superhard material is disposed in a second container, and the second container is disposed in the container.

3. The assembly according to claim 1, wherein the first metal is selected from any of titanium, zirconium, tantalum and alloys thereof.

4. The assembly according to claim 1, wherein the second metal is selected from any of copper and alloys thereof.

5. The assembly according to claim 1, wherein the first metal comprises titanium, the second metal comprises copper, and the composition comprises TiₓCu_{y}.

6. The assembly according to claim 1, wherein the container comprises:
an opening for receiving the superhard material;
a flange disposed around the opening;
wherein the sealant material is disposed between the flange and the closure; and
the flange is crimped to hold the closure in place.

7. The assembly according to claim 6, wherein the flange and the sealant material each have an annular shape.

8. The assembly according to claim 1, wherein the superhard material comprises any of diamond, cubic boron nitride, binder material and mixtures thereof.

9. A method of forming an assembly for High Pressure High Temperature, HPHT, synthesis of a superhard material, the method comprising:
locating superhard material in a container, the container comprising a first metal and having an opening;
disposing a closure to close the opening;
disposing a sealant material comprising a second metal between the closure and the container;
heating the assembly to a temperature below the melting point of the second metal and sufficient to form a seal between the container and the closure.

10. The method according to claim 9, further comprising, prior to locating the superhard material in the container, disposing the superhard material in a second container and locating the second container in the container.

11. The method according to claim 9, further comprising prior to heating the assembly, reducing the pressure around the assembly to perform outgassing.

12. The method according to claim 9, wherein the first metal is selected from any of titanium, zirconium, tantalum and alloys thereof.

13. The method according to claim 9, wherein the second metal is selected from any of copper and alloys thereof.

14. The method according to claim 9, wherein the first metal comprises titanium, the second metal comprises copper, and the composition comprises TiₓCu_{y}.

15. The method according to claim 9, wherein the container comprises a flange disposed around the opening, and the sealant material is disposed between the flange and the closure, the method further comprising:
crimping the flange such that flange material is folded over the closure and encloses the sealant material and an outer edge of the enclosure.

16. The method according to claim 15 wherein the flange and the sealant material each have an annular shape.

17. The method according to claim 9, wherein the container comprises a first cup having an outer diameter, and the closure comprises a second cup having a second cup opening, wherein an inner diameter of the second cup proximate to the second cup opening is greater than the outer diameter of the first cup, the method further comprising disposing the sealant material between the first cup and the second cup adjacent to the second cup opening.

18. The method according to claim 8, wherein the superhard material comprises any of diamond, cubic boron nitride, binder material and mixtures thereof.
